(19) United States
(12) Patent Application Publication
(10) Pub. No.: US 2004/0209541 A1
(43) Pub. Date: Oct. 21, 2004

(54) Lightweight nonwoven material and method of producing

(75) Inventor: Achai Bonneh, Kokhav Yair (IL)

Correspondence Address: Breiner & Breiner, L.L.C., P.O. Box 19290, Alexandria, VA, 22320-0290, US

(73) Assignee: Avgol Ltd., Holon (IL)

(21) Appl. No.: 10/841,564

(22) Filed: May 10, 2004

Related U.S. Application Data
(63) Continuation-in-part of application No. 10/194,321, filed on Jul. 15, 2002, now abandoned.
Application No. 10/194,321 is a continuation-in-part of application No. 10/109,665, filed on Apr. 1, 2002, now abandoned.

(51) Int. Cl. D04H 1/00; D04H 1/56; B32B 5/26; D04H 13/00; D04H 3/00; D04H 1/54; D04H 5/06; D04H 3/16; D04H 5/00; D04H 3/14

(52) U.S. Cl. 442/401; 442/382; 442/400; 442/409

(57) ABSTRACT

A lightweight nonwoven material is described. The nonwoven material includes at least three layers wherein a first layer is spunlaid, a second layer is meltblown, and a third layer is spunlaid, the first and third layers being external layers. The basis weight of the nonwoven material is 15.0 gsm or less and the weight of the second meltblown layer is about 5% or less of the total basis weight. The preferred polymer for the nonwoven material is polypropylene, in particular for the meltblown fibers is a resin having a molecular weight distribution Mw/Mn in a range of about 1.8-3.2. Hydrophilicity can be imparted to the nonwoven material by inclusion of a surfactant additive in an extrusion melt during formation of fibers, or by topical treatment following formation of the layers of the nonwoven material. The method of making the nonwoven material involves formation of the layers thereof as continuous fibers and forming the layers in a continuous sequential manner, i.e., a subsequent layer being formed on top of a preceding layer or layers.

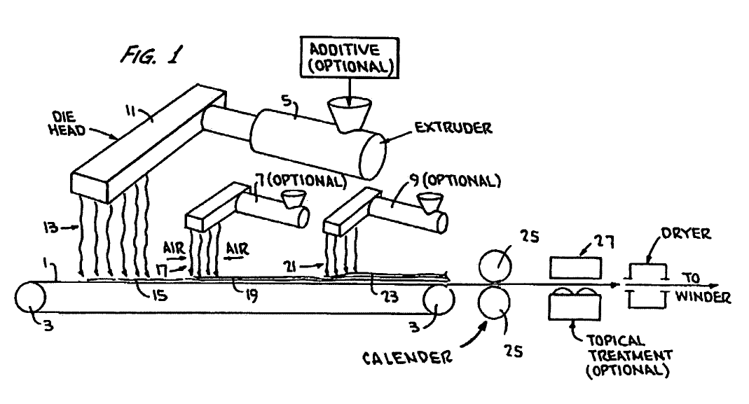

### RELATED APPLICATIONS

The present application is a continuation-in-part of Ser. No. 10/194,321 filed Jul. 15, 2002, which in turn is a continuation-in-part of Ser. No. 10/109,665 filed Apr. 1, 2002, now abandoned.

### FIELD OF INVENTION

The invention is directed to a nonwoven material which is lightweight, and useful as a hydrophobic barrier layer or hydrophilic layer if treated to be hydrophilic, as well as a method of making such nonwoven material. The nonwoven material is preferably a lightweight spunbond-meltblown-spunbond (SMS) nonwoven material which is, in particular, useful in personal care absorbent products, such as feminine hygiene products, diapers, adult incontinent products, etc., as well as for absorbent wipes and the like.

### BACKGROUND OF THE INVENTION

Standard SMS nonwoven products due to having a tight filament structure, have barrier properties with respect to body liquids and solid particles such as superabsorbent polymers (SAP), pulp, and the like. Thus, standard SMS products have bulk based on the material structure necessary to provide desired barrier properties and are hydrophobic in nature to prevent liquids from freely passing through the nonwoven material. Typical nonwoven structures can have a basis weight in a wide varying range, be a single or multiple layer product, and can be partially or completely, internally or topically, treated with a surfactant material to affect the hydrophobic properties of the nonwoven material. For example, U.S. Pat. No. 6,300,258 B1 discloses generally that a nonwoven web including a plurality of filaments made from one or more polymers, as utilized as a layer in forming a nonwoven single layer or multilayer composite, can have a basis weight ranging from about 0.1 gsm to 100 gsm (grams per square meter). These webs are recognized as being hydrophobic generally but also are recognized as being made hydrophilic upon treatment with a surfactant. The web can be a spunbond, meltblown or bonded carded web.

Generally, nonwoven composite materials have a basis weight in a range of from 5.0 gsm to 100.0 gsm. For example, U.S. Pat. No. 6,028,016 describes an SMS nonwoven having a basis weight in the range of 6-400 gsm. U.S. Pat. No. 6,060,638 describes a nonwoven material have a basis weight of 10-68 gsm, preferably 14-42 gsm. In the nonwoven material, the individual layers may have preferred ranges of basis weight depending on the overall structure provided and/or use to which the nonwoven is to be applied. For example, U.S. Pat. No. 5,492,751 describes a lightweight nonwoven composed of one fine fiber component layer having a basis weight of 1.5-30 gsm and one continuous filament layer with a basis weight of 5-30 gsm. The total basis weight is described as not exceeding 55 gsm. U.S. Pat. No. 4,436,780 describes a nonwoven material with a meltblown layer having a basis weight of 17-170 gsm (preferably 34-85 gsm) and a continuous filament layer of 7-34 gsm (preferably 10-17 gsm). U.S. Pat. No. 6,117,803 describes an outer cover for a personal care product having a meltblown fiber layer with a basis weight of 1-7 gsm. When utilized in combination with a spunbond layer, the material has a basis weight of 23 gsm or less and preferably about 17 gsm. U.S. Pat. No. 5,804,512 describes a nonwoven material which can be a laminate including a meltblown layer having a basis weight of 1-20 gsm, preferably 1-12 gsm.

Further, the layers may be made of staple or discontinuous fibers or of continuous fibers. In addition to the patents noted above, U.S. Pat. No. 6,183,847 B1 describes a one-piece web having a multi-component structure including at least one discontinuous fine fiber layer having a meltblown content of greater than zero but less than 1.5 gsm. The discontinuous fine fiber layer is stated to enhance liquid containment and liquid transport within the one-piece web.

Accordingly, various combinations of materials are known including within a wide range of basis weights yet a need remains for a lightweight nonwoven composite material which retains strength characteristics and is capable of withstanding processing treatments, such as surfactant treatment to provide hydrophilicity to the material, and suitable for a variety of uses, such as in personal care products as well as dry or wet wipes.

Accordingly, it would be beneficial to provide a material which is lightweight and has less bulk, while optionally being treated to be hydrophilic, and having strength characteristics making the nonwoven material more suitable for use in various personal care applications and wipe applications, and able to provide for the retention of various solids particles in the products in which the nonwoven material is used.

### OBJECTS OF THE INVENTION

Accordingly, a primary object of the present invention is to provide a lightweight nonwoven material.

More particularly, it is an object of the invention to provide a lightweight nonwoven material having at least three layers (SMS) and an overall or total basis weight in a range of about 15.0 gsm or less but greater than zero, and a weight for the meltblown layer of less than about 5.0% by weight but greater than zero of the total basis weight of the nonwoven material.

It is a further object of the invention, that the meltblown layer and spunbond layers be made of continuous fibers.

It is a further object that the lightweight nonwoven material will have a hydrostatic head of at least about 125 mm, and, if desired, can be rendered at least in part hydrophilic so as to allow fluids to pass through the nonwoven material.

It is a further object of the invention to provide a lightweight nonwoven material which can act at least in part as a barrier against the migration or movement of solid particles or components contained in a product in which the nonwoven material is used.

A further object is to provide a method of making such lightweight nonwoven material.

### BRIEF DESCRIPTION OF THE INVENTION

A lightweight SMS (spunbond/meltblown/spunbond) nonwoven material of the invention includes at least three layers, a first or bottom layer of spunbond fiber, a second or middle layer of meltblown fiber which is about 5% weight content or less but greater than zero of the total nonwoven material weight, and a third or top layer of spunbond fiber. The fibers in each of the spunbond layers are continuous fibers. The fibers of each layer are preferably of a thermoplastic polymer, more preferably a polyolefin, and most preferably polypropylene. The meltblown resin has a molecular weight distribution Mw/Mn in a range of about 1.8-3.2. The nonwoven material of the invention based on the described structure has a hydrostatic head of at least about 125 mm, preferably at least about 140 mm. Hydrostatic head indicates the ability of a fabric to withstand water penetration by measuring the height of a column of water applied to a sample required to effect water penetration of the sample. This provides an indication of performance by the nonwoven material. The hydrostatic head herein was measured according to EDANA (European Disposables and Nonwovens Association) Test Method 120.1-80. EDANA test methods are used to test various properties of nonwovens so as to provide a common standard of measurement. The nonwoven material, if desired, can be rendered all or at least in part hydrophilic by including a suitable additive, in liquid or solid form, in the polymer melt to be extruded during production of one or more layers of the nonwoven material, or by topically treating the nonwoven material following formation of the multi-layer nonwoven material. The additive or topical treatment involves the use of a surfactant.

The invention involves a low meltblown fiber content in the nonwoven material in order to maintain high density of fibers in order to serve as a barrier to liquids, typically body fluids. The fabric of the invention can prevent movement or migration of solids from one side to another of the material while at the same time allowing fluids to move through quickly based on additive or topical treatment with a surfactant. The meltblown content is preferably in a range of about 5% by weight or less, preferably 4% by weight or less, but greater than zero of the total material and the surfactant is preferably from about 0.2-3.0% by weight. More particularly, the basis weight of the overall nonwoven material is about 15.0 gsm (grams per square meter) or less yet greater than zero, and the weight of the meltblown layer is as set forth above, i.e., about 5% by weight or less yet greater than zero, most preferably the weight of the meltblown layer is about 4% by weight or less. A preferred meltblown polymer will have a molecular weight distribution of about 1.8-3.2 Mw/Mn.

A preferred surfactant for use as an additive in an extrusion melt is STANDAPOL™ 1480 as sold by Cognis, which is a fatty ester. A preferred surfactant for use in a topical treatment of the formed nonwoven material is STANTEX® S 6327, as sold by Cognis, which is a blend of fatty acid esters. An example of a suitable topical treatment for imparting hydrophilicity to the nonwoven material is as described in U.S. Pat. Nos. 5,709,747 and 5,885,656, the disclosure of each patent being incorporated herein by reference.

The lightweight hydrophilic nonwoven material of the invention is advantageous in providing improved processability, higher strength, and requires less roll changes on machines.

The nonwoven fabrics of the invention are useful in a wide variety of applications. For example, the nonwoven material is useful as a component of absorbent products such as disposable diapers, feminine hygiene products, adult incontinent products; medical products such as surgical gowns and masks; disposable dry or wet wipes; industrial garments; filtration media; etc.

### BRIEF DESCRIPTION OF DRAWING

The sole FIGURE is a schematic of the production method of a SMS nonwoven material of the invention.

### DETAILED DESCRIPTION OF PRESENTLY PREFERRED EMBODIMENTS

The lightweight nonwoven material of the present invention includes at least a first layer of spunbond fibers, a second layer of meltblown fibers, and a third layer of spunbond fibers, wherein the first and third layers are external layers of the nonwoven material. The fibers forming the at least three layers are polymeric and the spunbond fibers are continuous. The meltblown fibers may be continuous but are not required to be. The fibers can be made using conventional extrusion apparatus and techniques.

To provide the nonwoven as lightweight while retaining and improving high strength and improved hydrostatic head, both during manufacture and after manufacture, the nonwoven material has a basis weight of about 15.0 gsm or less but greater than zero and the layer of meltblown fibers has a weight of about 5% or less of the total basis weight but greater than zero, most preferably of about 4% or less but greater than zero.

The fibers of the layers are made of a thermoplastic polymer. Suitable polymers include polyolefins such as polypropylene and polyethylene; polyesters such as polyethylene terephthalate; polyamides; polyacrylates; polystyrene; thermoplastic elastomers; and blends of these and other known fiber forming thermoplastic materials. The preferred useful polymer is polypropylene. The meltblown polymer has a molecular weight distribution Mw/Mn in the range of about 1.8 to 3.2.

Hydrophilicity can be imparted to at least one areal portion of or completely to the nonwoven material depending on the use to which the nonwoven material is to be applied. The manner of imparting the hydrophilic property to the nonwoven can be based on a solid or liquid additive to an extrusion melt used in forming one or more of the layers or by topical treatment. This will be further evident from the description below of the method of making the nonwoven material.

The method of the invention for making a lightweight hydrophilic nonwoven material will be described in relation to the sole FIGURE. An advantage of the method of the invention is the provision of a multi-layer nonwoven material in a process which combines the manufacture of continuous thermoplastic polymer fibers, the formation of a layer therefrom and the combining of multiple layers so as to provide a finished product in one manufacturing line. This improves on conventional multi-stage processes wherein staple fibers are made by a first process and used to form a product in a separate process or a first layer is made and then processed for storage or use in another process. The conventional processes require multiple lines and stages which necessarily include lost or down time between processing stages. The invention provides for a consolidated continuous process in terms of space, time, material storage, etc.

With reference to the sole FIGURE, a conveyor or belt 1 moving continuously along rollers 3 is provided beneath the exit orifices for extruders 5, 7 and 9. Extruder 5 receives a polymeric melt which is extruded through a substantially linear diehead 11 to form a plurality of continuous fibers 13 which randomly fall to conveyor 1 to form a layer 15 of spunlaid fibers thereon. The extrusion process parameters used are conventional and as known to one skilled in the art. The diehead includes a spaced array of die orifices having diameters of preferably about 0.1 to about 1.0 millimeters (mm). The continuous filaments following extrusion are quenched, such as by cooling air.

Positioned downstream in relation to the conveyor 1 in the processing direction is extruder 7 for providing meltblown fibers 17.

In meltblowing, a thermoplastic polymer, preferably polypropylene, is fed into an extruder where it is melted and heated sufficiently to form fibers from the polymer. The molten polymer is fed to an extrusion diehead having a spaced array of die orifices. The orifices preferably have a diameter from about 0.1 to 0.5 mm. The polymer issues as molten streams of fibers 17 into converging streams of a heated gas, such as air. The air attenuates the stream of fibers which fall to conveyor 1 and are laid in the process upon layer 15 of spunmelt fibers forming a second layer 19. The meltblown fibers are entangled as they fall to provide a cohesive layer.

Further positioned downstream is extruder 9 for making additional continuous spunlaid fibers 21 as described in relation to continuous fibers 13. Fibers 21 randomly fall to conveyor 1 and are laid atop layer 19 to form a third layer 23. Thus along one conveyor line a SMS nonwoven material is provided using continuous fibers.

The stacked layers are then bonded together to form a coherent material using processes as known to one skilled in the art. For example, the three layers can be bonded by being passed through calendering rollers 25 to join the layers together by mechanical interlocking. Other conventional processes such as thermal bonding, adhesive bonding, hydroentanglement, needle punching and the like, are also suitable for use.

Hydrophilic properties can be imparted to the nonwoven material in different ways. Following calendering, the nonwoven material can be subjected to topical treatment 27, such as described in U.S. Pat. Nos. 5,709,747 and 5,885,656 which are incorporated herein by reference. As described therein, topical treatment can be to preselected areas depending on the use to which the nonwoven will be applied. For example, if used in the manufacture of a diaper, a central areal portion may be treated with a surfactant to impart a hydrophilic character thereto. A suitable surfactant for use is STANTEX® S 6327, as sold by Cognis, and which is a blend of fatty acid esters. The surfactant is a liquid suitable for topical application to the nonwoven material. Other examples of surfactants suitable for use include PPH 53 as sold by Dr. Bohme GmbH, Germany and PP 842 as sold by Uniquema, United Kingdom.

Alternatively, hydrophilic properties can be imparted to the nonwoven material by providing a suitable surfactant additive to the extrusion melt fed to one or more of extruders 5, 7 and/or 9. A suitable surfactant additive is STANDAPOL™ 1480, sold by Cognis, which is a fatty ester. This additive is present in granular form. Other examples of surfactants suitable for use include PPH 53, as sold by Dr. Bohme GmbH, Germany and PP 842 as sold by Uniquema, United Kingdom. Whether a surfactant additive is fed to one or more of extruders 5, 7 and/or 9 depends on the characteristics of the nonwoven material desired. For example, whether a complete strike through of liquid is desired or only a partial strike through is desired.

When the meltblown content is about 5% or less but greater than zero in weight based on the total weight of the nonwoven material, the surfactant is preferably about 0.2-3.0% by weight of the nonwoven material.

The nonwoven material of the invention is particularly suitable to act as a barrier for body fluids and against movement or migration of solid particles. For example in baby diapers, adult incontinent products and feminine hygiene products, superabsorbent polymers (SAPs) are commonly used. The SAPs are required to stay positioned in a certain area of the product for the product to effectively serve its intended purpose. The nonwoven material of the invention, due to its structure being both lightweight and capable of being made as a tight filament structure, is particularly effective as a barrier without adding undesirable bulk or weight.

A lightweight nonwoven material of the invention can be produced with a variety of structures. Examples of nonwoven materials and specific properties with respect thereto are set forth in Table 1 below.

TABLE 1

| | 15 gsm SMS | 15 gsm phobic | |
|---|---|---|---|
| | with w/0.6 | SMS w/0.6 | 13.5 gsm SMS |
| | gsm MB | gsm MB | w/0.5 gsm MB |
| Basis weight | 15.0 | 15.0 | 13.5 |
| (gsm) | | | |
| MD Tensile Strength | 35.72 | 33.9 | 33.554 |
| (N/5 cm) | | | |
| MD Tensile Elongation | 63.34 | 61.84 | 62.4774 |
| (%) | | | |
| CD Tensile strength | 17.44 | 17.96 | 13.923 |
| (N/5 cm) | | | |
| CD Tensile Elongation | 68.84 | 71.38 | 63.4437 |
| (%) | | | |
| Water Column (HSH | 162 | 145 | 145.307 |
| Value) (mm) | | | |
| Air Permeability | 3218.00 | 3152.00 | 4290 |
| (1/m2/s) | | | |
| Mean Pore Flow Size | 31.51 | 31.51 | |
| (Micron) | | | |
| Surface Linting | 0.729 | 0.729 | |
| Embossed Side (g) | | | |
| Surface Listing | 1.067 | 1.067 | |
| Smooth Side (g) | | | |
| Fabric Thickness (mm) | 0.109 | 0.109 | |

MD = Machine direction
CD = Cross direction
HSH = Hydrostatic Head

As will be apparent to one skilled in the art, various modifications can be made within the scope of the aforesaid description. Such modifications being within the ability of one skilled in the art form a part of the present invention and are embraced by the appended claims.

It is claimed:

1. A nonwoven material comprising at least three layers comprising (a) a first layer of continuous spunbond fibers, (2) a second layer of meltblown fibers and (3) a third layer of continuous spunbond fibers, wherein the first layer and the third layer are each an external layer to said nonwoven material, said at least three layers having a basis weight of about 15.0 gsm or less but greater than zero, said second layer has a weight of about 5% or less of the total basis weight but greater than zero, and said nonwoven material has a hydrostatic head of at least about 125 mm.

2. The nonwoven material of claim 1 wherein the weight at the second layer is about 4% or less but greater than zero.

3. The nonwoven material of claim 1 wherein the hydrostatic head is at least about 140 mm.

4. The nonwoven material of claim 1 wherein the nonwoven material includes at least one portion which is hydrophilic.

5. The nonwoven material of claim 1 wherein said spunbond fibers of said first layer and said third layer and said meltblown fibers of said second layer comprise a polyolefin.

6. The nonwoven material of claim 5 wherein said polyolefin is polypropylene.

7. The nonwoven material of claim 5 wherein said polyolefin of said meltblown fibers has a molecular weight distribution Mw/Mn in a range of about 1.8-3.2.

8. The nonwoven material of claim 6 wherein said polyolefin of said meltblown fibers has a molecular weight distribution Mw/Mn in a range of about 1.8-3.2.

9. The nonwoven material of claim 4 further comprising at least one surfactant to render said at least one portion hydrophilic.

10. The nonwoven material of claim 9 wherein said at least one surfactant is incorporated in said spunbond fibers of said first layer.

11. The nonwoven material of claim 9 wherein said at least one surfactant is present at least topically on at least one of said first layer or said third layer.

12. The nonwoven material of claim 1 wherein said nonwoven material comprises a component of a personal care product or a wipe.

13. The nonwoven material of claim 9 wherein said surfactant is a fatty acid ester or blend of fatty esters.

14. The nonwoven material of claim 1 wherein the fibers of at least one layer of said nonwoven material are adapted to provide a barrier structure to solid particles.

15. Method of producing a lightweight nonwoven material including at least three layers, said method comprising
providing a first extrusion thermoplastic polymeric material, extruding said material to form continuous fibers and forming therefrom a first layer of spunlaid fibers;
providing a second extrusion thermoplastic polymeric material, extruding said material to form spunmelt fibers and forming therefrom a second layer of meltblown fibers on top of said first layer;
providing a third extrusion thermoplastic polymeric material, extruding said material to form continuous fibers and forming therefrom a third layer of spunlaid fibers on top of said second layer; and
bonding said first layer, said second layer and said third layer to provide a combined structure;
wherein the basis weight of said first layer, said second layer and said third layer is about 15.0 gsm or less but greater than zero, the weight of said second layer is about 5% or less of the total basis weight but greater than zero, and said nonwoven material has a hydrostatic head of at least about 125 mm.

16. The method of claim 15 wherein the weight of the second layer is about 4% or less but greater than zero.

17. The method of claim 15 wherein the hydrostatic head is at least about 140 mm.

18. The method of claim 15 wherein the nonwoven material includes at least one portion which is hydrophilic through inclusion therein of a surfactant.

19. Method of producing a lightweight nonwoven material including at least three layers, said method comprising
providing a first extrusion thermoplastic polymeric material, extruding said material to form continuous fibers, and forming therefrom a first layer of spunlaid fibers;
providing a second extrusion thermoplastic polymeric material, extruding said material to form spunmelt fibers, and forming therefrom a second layer of meltblown fibers on top of said first layer;
providing a third extrusion thermoplastic polymeric material, extruding said material to form continuous fibers, and forming therefrom a third layer of spunlaid fibers on top of said second layer;
bonding said first layer, said second layer and said third layer to provide a combined structure; and
subjecting said combined structure to topical treatment with a surfactant to render at least one portion of said combined structure hydrophilic;
wherein the basis weight of said first layer, said second layer and said third layer is about 15.0 gsm or less but greater than zero, the weight of said second layer is about 5% or less of the total basis weight but greater than zero, and said nonwoven material has a hydrostatic head of at least about 125 mm.

20. The method of claim 19 wherein the weight of the second layer is about 4% but greater than zero.

21. The method of claim 19 wherein the hydrostatic head is at least about 140 mm.

22. The method according to claim 15 or 19 wherein said extrusion thermoplastic polymeric material comprises a polyolefin.

23. The method according to claim 22 wherein said polyolefin is polypropylene.

24. The method according to claim 22 wherein said polyolefin of said meltblown fibers has a molecular weight distribution Mw/Mn in a range of about 1.8-3.2.

25. The method according to claim 23 wherein said polyolefin of said meltblown fibers has a molecular weight distribution Mw/Mn in a range of about 1.8-3.2.

26. The method according to claim 18 or 19 wherein said surfactant is a fatty acid ester or a blend of fatty esters.

27. The method according to claim 15 or 19 wherein said first layer is formed on a moving surface which, following formation of said first layer moves said first layer such that said second layer is formed on top of said first layer, and thereafter moving such that said third layer is formed on top of said second layer.

28. The method according to claim 15 or 19 wherein said bonding is by calendering, heating, hydroentanglement or needle punching.

29. The method according to claim 18 or 19 wherein said surfactant is present in an amount of from about 0.2% to about 3.0% of the total weight of said combined structure.
